(19) United States
(12) Patent Application Publication
(10) Pub. No.: US 2012/0278751 A1
(43) Pub. Date: Nov. 1, 2012

(54) INPUT METHOD AND INPUT MODULE THEREOF

(76) Inventors: Chih-Yu Chen, Taipei (TW); Chun-Hao Tseng, Taipei (TW); Chih-Chieh Hsu, Taipei (TW)

(21) Appl. No.: 13/458,867

(22) Filed: Apr. 27, 2012

(30) Foreign Application Priority Data
Apr. 29, 2011 (TW) 100115142

(51) Int. Cl. G06F 3/048

(52) U.S. Cl. 715/780

(57) ABSTRACT

An input method applied to an electronic device which can execute a text editing function is disclosed. The input method includes following steps: triggering a multi-function calling unit to execute an auxiliary input function which provides at least one application module when the text editing function is executed; selecting and executing the application module; and providing an assistance function. When the auxiliary input function is executed, the text editing function continues being executed. According to the disclosure, users can use multi-function operation while information input with a portable electronic device. That is, users do not need to jump out from the window of the input program to the computer operation system to look up for another assistant program, but can edit a document efficiently and smoothly.

### CROSS REFERENCE TO RELATED APPLICATIONS

This application claims the priority benefit of Taiwan application serial no. 100115142, filed on Apr. 29, 2011. The entirety of the above-mentioned patent application is hereby incorporated by reference herein and made a part of specification.

### BACKGROUND OF THE INVENTION

1. Field of Invention

The invention relates to an input method and an input module and, more particularly, to an input method and an input module for a portable electronic device.

2. Related Art

As science technology develops, various portable computers, such as a mobile phone, a personal digital assistant (PDA) and a tablet computer, are available in market. Users input information simply by fingers, such as a short massage, a document or an e-mail in spare time. However, users might need multi-function operation while information input. Users often have to stop the inputting program and jump out of the input window to look for another software or hardware for assistance. For example, if the user forgets the spelling of a word while texting, he or she needs to stop the inputting program, jump out of the window, go back to the operation system and execute a translation program. After the translation, he or she would go back to the document window to input/insert the correct word. If the user needs to insert an image or recognize characters on an certain image while inputting words, he or she also needs to stop the inputting program, jump out of the window and go back to the operation system to look for an assistant program.

Consequently, the operation takes a long time and is complicated, the user may feel inconvenient, and working efficiency is reduced.

### SUMMARY OF THE INVENTION

An input method and an input module are disclosed.

The input method is applied to an electronic device, and the electronic device can execute a text editing function. The input method includes following steps: triggering a multi-function calling unit to execute an auxiliary input function which provides at least one application module when the text editing function is executed; selecting and executing the application module; and providing an assistance function. When the auxiliary input function is executed, the text editing function continues being executed.

The input module is applied to an electronic device, and the electronic device includes a display unit. The input module includes a text editing unit and a multi-function calling unit. The text editing unit provides a text editing function. The multi-function calling unit calls an auxiliary input menu. The auxiliary input menu provides at least one application module which provides an assistance function. When the auxiliary input menu is executed, the text editing function continues executing.

The electronic device may be a mobile phone, a PDA, a tablet computer, a notebook computer or a desktop computer, which is not limited herein.

These and other features, aspects and advantages of the present invention will become better understood with regard to the following description, appended claims, and accompanying drawings.

### BRIEF DESCRIPTION OF THE DRAWINGS

FIG. 1 is a flow chart showing steps of a input method in an embodiment;

FIG. 2 to FIG. 9 are schematic diagrams showing a input method in a first embodiment;

FIG. 10 to FIG. 16 are schematic diagrams showing a input method in a second embodiment;

FIG. 17 to FIG. 21 are schematic diagrams showing a input method in a third embodiment; and

FIG. 22 and FIG. 23 are block diagrams showing an input module in an embodiment.

### DETAILED DESCRIPTION OF THE INVENTION

A input method and a input module are illustrated with relating figures, and the same symbols denote the same components.

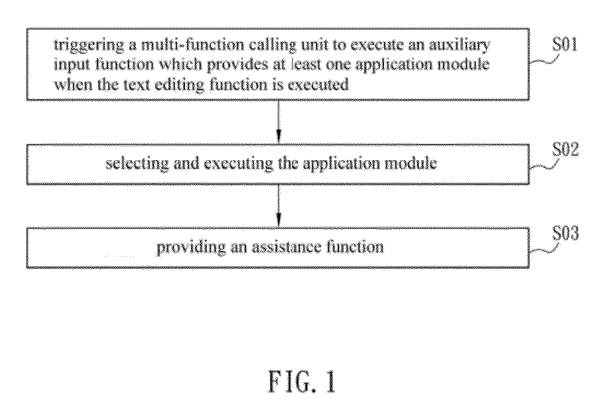

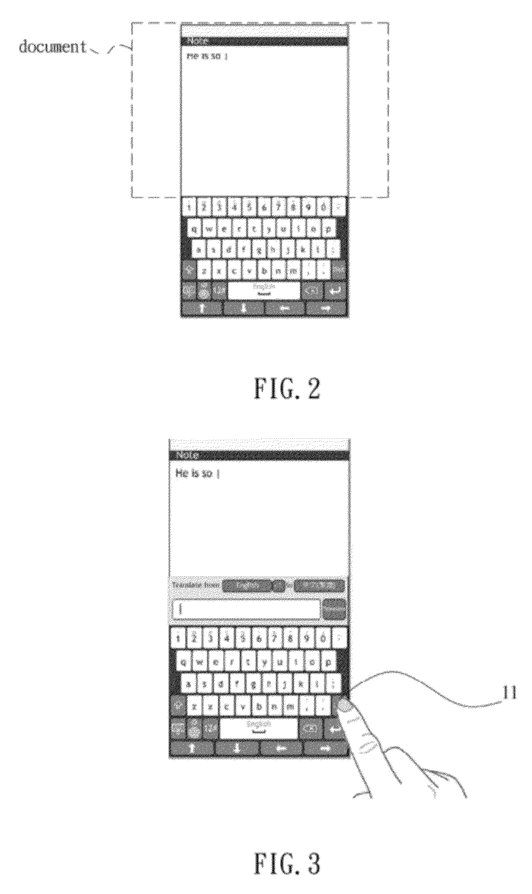

FIG. 1 is a flow chart showing steps S01 to S03 of a input method in an embodiment. The input method is applied to an electronic device. The electronic device includes a display unit displaying a document, and the electronic device can execute a text editing function. FIG. 2 to FIG. 9 are schematic diagrams showing a input method in a first embodiment. As shown in FIG. 2, a smart phone without a physical keyboard is taken as an example of an electronic device, and an input interface is displayed via the display unit for the user to touch and input.

In step S01, a multi-function calling unit is triggered to execute an auxiliary input function to provide at least one application module when the text editing function is executed. The auxiliary input function provides an auxiliary input menu displaying at least one application module, and the application module may be a translation dictionary module, an image recognition module and a voice recognition module, which is not limited herein. The translation dictionary module translates words, the image recognition module can identify images and convert the images to words, and the voice recognition module can identify voice and convert the voice to text.

The input method is used when the user is editing a document, which means the text editing function is executed. For example, as shown in FIG. 2, after the user writes “He is so”, he or she forgets or does not know the spelling of an English word, the user can trigger the multi-function calling unit 11 (which may be enabled via a touch control button in FIG. 3), and the multi-function calling unit 11 executes the auxiliary input function to provide the auxiliary input menu 12 (as shown in FIG. 4). The auxiliary input menu 12 includes at least one option for the user to select, and the option corresponds to at least one application module. The application module may be, but not limited to, a translation dictionary module, an image recognition module or a voice recognition module. In FIG. 4, the auxiliary input menu 12 includes three options as an example. The application module of the auxiliary input function may further include a handwritten recognition module, a lip-language identification module, a recording module, or other modules. The handwritten recognition module can convert handwriting to words or images, the lip-language identification module can convert lip language to words via lip read technology, and the recording module can record the voice of the user.

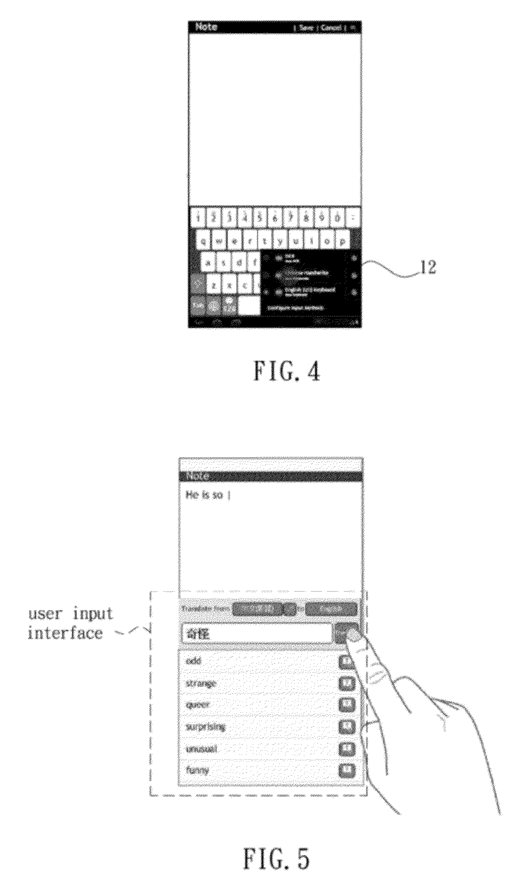

In step S02, the application module is selected and executed. In the embodiment, the auxiliary input menu is clicked to execute the auxiliary input function. As shown in FIG. 5, since the user needs a translation dictionary function, the translation dictionary module is selected.

In step S03, an assistance function is provided. In the embodiment, the executed application module assists the user to edit the document. When the user clicks the application module and the electronic device executes the application module, the application module provides an assistance function different from the text editing function to assist the user to edit the document. That is, the assistance function may provide a function having features different from the text editing function, such as an auxiliary inserting operation with multiple functions, effects or modes, so as to provide inputting information and editing assistance. After the application module is selected and executed, auxiliary input information is generated, and the assistance function includes inserting the auxiliary input information in the document.

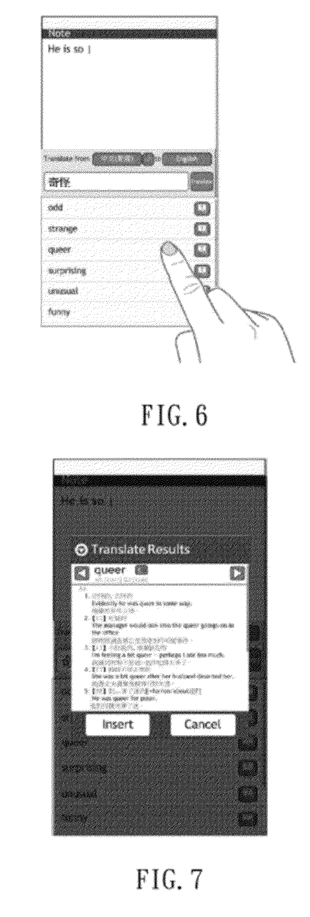

The auxiliary input function includes providing a user input interface. As shown in FIG. 5, when the user selects the translation dictionary module, the electronic device provides a user input interface of a translation dictionary for the user to operate, and the user input interface is displayed below the document to facilitate the user. In FIG. 5, when the user inputs two Chinese characters and clicks the English word “queer” at the interface in FIG. 6, an explanation window of the English word is displayed as shown in FIG. 7.

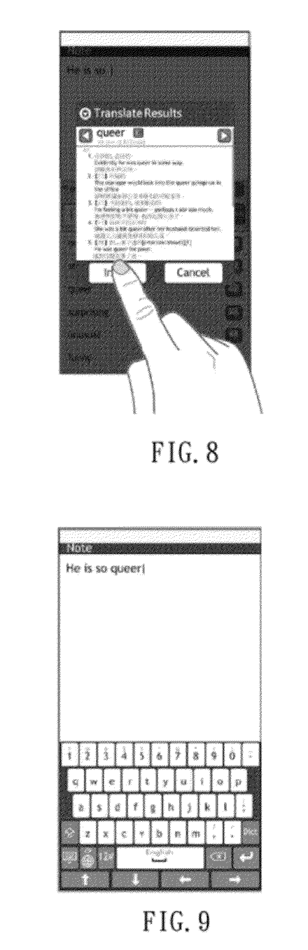

The input method further includes operating an application module providing the auxiliary input function to generate the auxiliary input information and inserts the auxiliary input information to the document. As shown in FIG. 8, the user operates the application module which executes the auxiliary input function, the application module generates the auxiliary input information, such as the English word “queer” shown in FIG. 8, and the user clicks an inserting button to insert the word “queer” after the position of the “He is so” as shown in FIG. 9. Thus, the user does not need to jump to the computer operation system to execute the application program at a new window, and the user can finish the editing at the same text editing window. The auxiliary input information is a word in the embodiment, which is not limited herein. The auxiliary input information may also be images or sound.

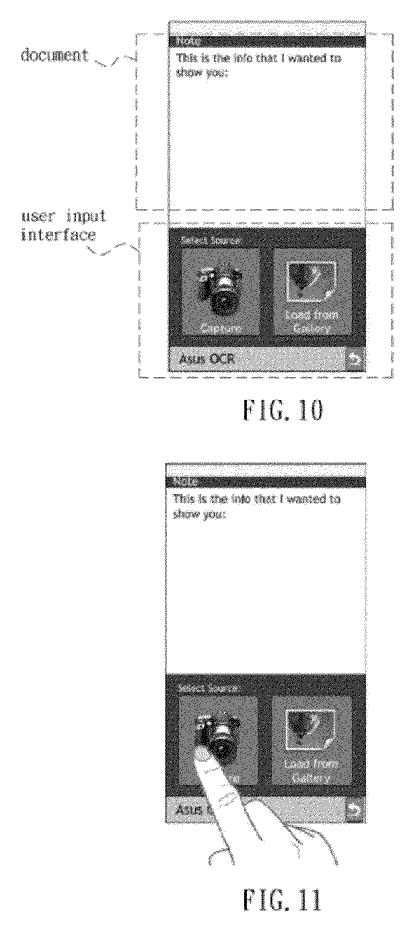

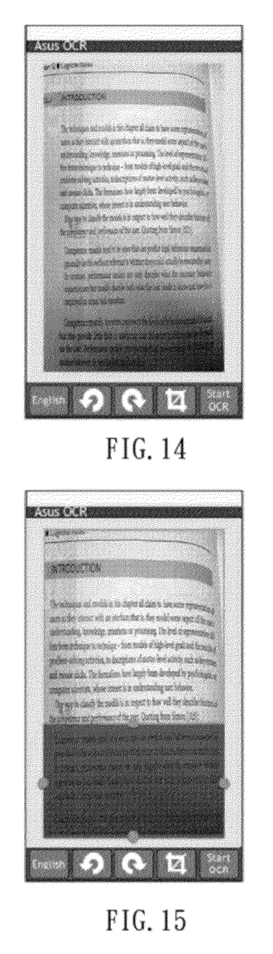

FIG. 10 to FIG. 16 are schematic diagrams showing a input method in a second embodiment. In FIG. 10, the user is editing a document, and he or she writes “This is the info that I wanted to show you:”. Then, the user needs an application module to assist the editing. As stated in step S01, the multi-function calling unit is triggered to execute the auxiliary input function and provide the auxiliary input menu (not shown). The auxiliary input menu displays a plurality of the application modules including a translation dictionary module, an image recognition module, a voice recognition module, a handwritten recognition module, a lip-language identification module and a recording module (not shown). The user selects the image recognition module according to requirements. Figures of the steps stated above are omitted.

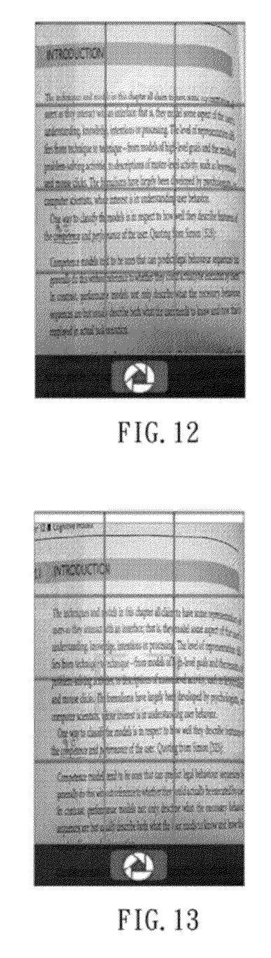

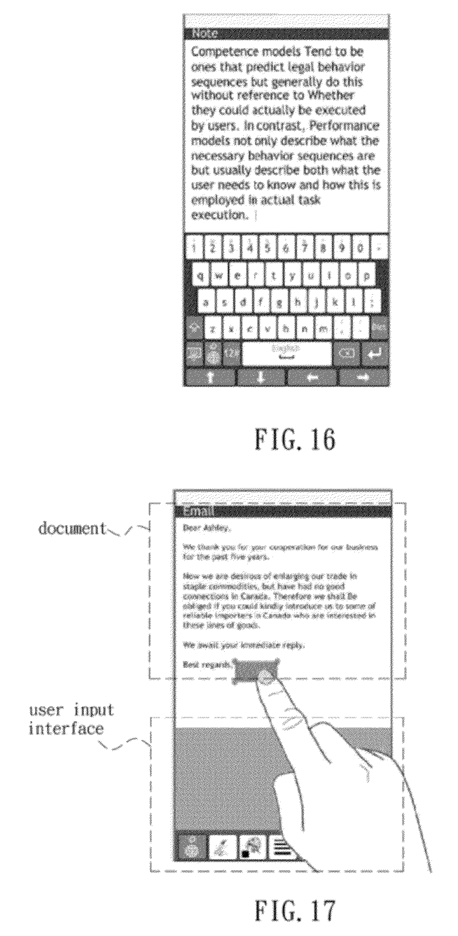

As shown in FIG. 10, the electronic device provides a user input interface corresponding to, the image recognition module for the user to operate. The user input interface displays two options for the user to select an image source. As shown in FIG. 11, the user selects “capture” as the image source. FIG. 12 to FIG. 14 are schematic diagrams showing a process of taking pictures. In FIG. 15, the user selects a part of the image for identification. In FIG. 16, after the image recognition is finished, the image is converted to words, and the words are inserted to the document. Thus, the user does not need to jump to the computer operation system to execute the application program, and the user can finish the editing directly.

FIG. 17 to FIG. 21 are schematic diagrams showing a input method in a third embodiment. Figures showing that the user triggers the multi-function calling unit and clicks the auxiliary input menu to execute the application module are omitted.

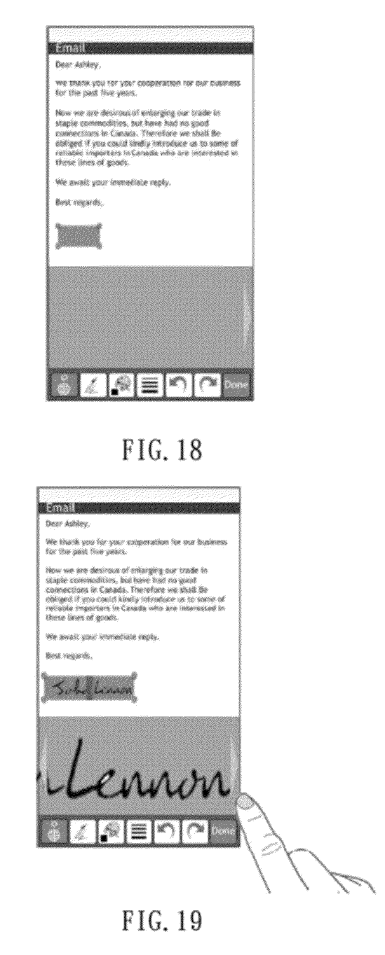

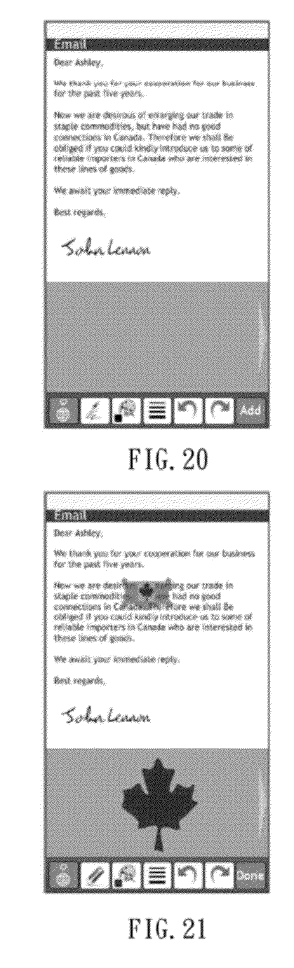

In FIG. 17, the user is writing an e-mail and wants to insert a handwritten signature and an image. Thus, the user triggers the multi-function calling unit and selects the handwritten recognition module at the auxiliary input menu. The electronic device provides a user input interface corresponding to the application module for the user to operate. The handwritten recognition module provides a box to display the handwritten words or the image. FIG. 18 shows that the user moves the box to a proper position. In FIG. 19, after the user writes a signature, he or she can select to insert the signature to the document, as shown in FIG. 20. In FIG. 21, the user inserts an image of a maple leaf, and the image may be chosen from an image gallery or drawn by the user.

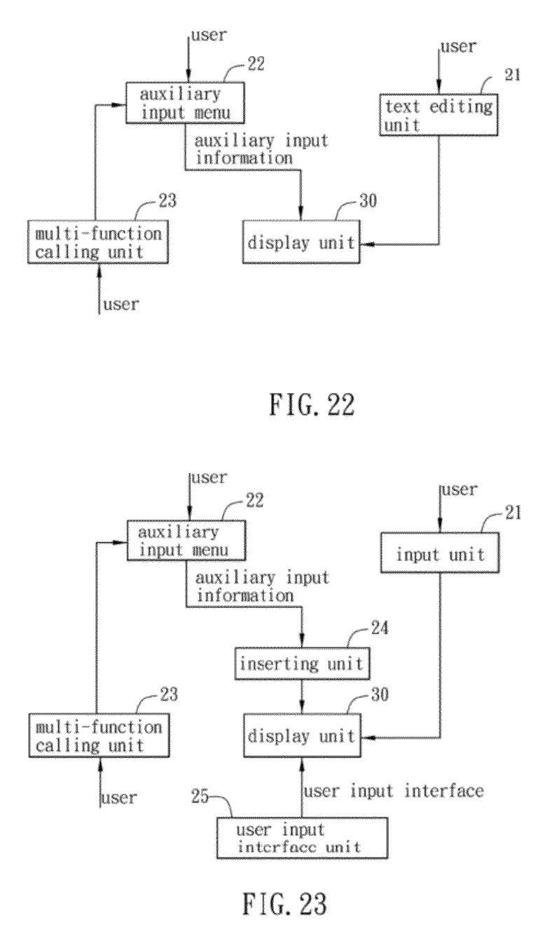

FIG. 22 is a block diagram showing a input module 2 in an embodiment. The input module 2 is applied to an electronic device, and the electronic device includes a display unit 30 displaying a document. The electronic device may be a mobile phone, a PDA, a tablet computer, a notebook computer or a desktop computer.

The input module 2 includes a text editing unit 21, an auxiliary input menu 22 and a multi-function calling unit 23. The text editing unit 21 provides a user input frame to directly edit the document. The auxiliary input menu 22 assists the user in editing the document, and the auxiliary input menu includes one or more application modules such as a translation dictionary module, an image recognition module and a voice recognition module. The multi-function calling unit 23 is triggered to call the auxiliary input menu 22, and thus the user can directly edit the document via the translation dictionary module, the image recognition module and the voice recognition module of the auxiliary input menu.

Furthermore, the application module of the auxiliary input menu 22 may further include a handwritten recognition module, a lip-language identification module or a recording module.

When the user executes the application module, the application module generates auxiliary input information such as a word, an image or sound.

FIG. 23 is a block diagram showing a input module in another embodiment. The input module 2 further includes an inserting unit 24 to insert the auxiliary input information to the document. The input module 2 further includes a user input interface unit 25. The user input interface unit 25 provides a user input interface corresponding to the application module of the auxiliary input menu 22 for the user to operate, and the user input interface is displayed via the display unit.

The operation method of the diverse input module input module 2 is similar with the input method, and thus the details are omitted herein.

In sum, a input method and a input module provide a text editing unit and a multi-function calling unit. The text editing unit provides a text editing function. The multi-function calling unit is triggered to call an auxiliary input function or an auxiliary input menu. The auxiliary input function or the auxiliary input menu provides at least one application module, and the application module can provide an assistance function different from the text editing function. When the auxiliary input function or the auxiliary input menu is executed, the text editing function continues being executed.

Consequently, the user does not need to pause the text editing program and jump out of the window to look for a corresponding software or hardware assistance. The user can directly and rapidly edit the document by executing a selected application module, which saves operation time and improves using efficiency and competitive force of products.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An input method applied to an electronic device, wherein the electronic device executes a text editing function, the input method comprising following steps:
triggering a multi-function calling unit to execute an auxiliary input function, at least one application module is provided when the text editing function is executed;
selecting and executing the application module; and
providing an assistance function;
wherein when the auxiliary input function is executed, the text editing function continues executing.

2. The input method according to claim 1, wherein the input method further includes generating auxiliary input information after the step of selecting and executing the application module.

3. The input method according to claim 2, wherein the assistance function includes inserting the auxiliary input information to a document.

4. The input method according to claim 2, wherein the auxiliary input information is a word, an image or sound.

5. The input method according to claim 1, wherein the auxiliary input function provides a user input interface.

6. The input method according to claim 1, wherein the application module is a translation dictionary module, an image recognition module, a voice recognition module, a handwritten recognition module, a lip-language identification module or a recording module.

7. An input module applied to an electronic device with a display unit, the input module comprising:
a text editing unit executing a text editing function; and
a multi-function calling unit calling an auxiliary input menu, wherein the auxiliary input menu provides at least one application module which provides an assistance function;
wherein when the auxiliary input menu is executed, the text editing function continues executing.

8. The input module according to claim 7, wherein auxiliary input information is generated after the application module is executed.

9. The input module according to claim 8, wherein the assistance function includes inserting the auxiliary input information to a document.

10. The input module according to claim 8, wherein the auxiliary input information is a word, an image or sound.

11. The input module according to claim 7, wherein the input module further includes:
a user input interface unit providing a user input interface and displaying the user input interface at the display unit.

12. The input module according to claim 7, wherein the application module of the auxiliary input menu includes a translation dictionary module, an image recognition module, a voice recognition module, a handwritten recognition module, a lip-language identification module and a recording module.
